(19) United States
(12) Patent Application Publication
(10) Pub. No.: US 2023/0120772 A1
(43) Pub. Date: Apr. 20, 2023

(54) METHODS, SYSTEMS, AND DEVICES FOR ON-DEMAND REUSE OF VOLUMETRIC CONTENT

(71) Applicant: AT&T Intellectual Property I, L.P., Atlanta, GA (US)

(72) Inventors: Eric Zavesky, Austin, TX (US); David Crawford Gibbon, Lincroft, NJ (US); Tan Xu, Bridgewater, NJ (US); Wen-Ling Hsu, Bridgewater, NJ (US); Richard Palazzo, Stewartsville, NJ (US)

(73) Assignee: AT&T Intellectual Property I, L.P., Atlanta, GA (US)

(21) Appl. No.: 17/501,577

(22) Filed: Oct. 14, 2021

(51) Int. Cl. H04N 21/472; H04N 21/81; H04N 21/84

(52) U.S. Cl. CPC H04N 21/47202; H04N 21/8146; H04N 21/84

(57) ABSTRACT

Aspects of the subject disclosure may include, for example, obtaining a first group of volumetric content, generating first metadata for the first group of volumetric content, and storing the first group of volumetric content. Further embodiments include obtaining a second group of volumetric content, generating second metadata for the second group of volumetric content, and storing the second group of volumetric content. Additional embodiments include receiving a request for user volumetric content, and obtaining first volumetric content according to the request, the first group of volumetric content comprises the first volumetric content, and obtaining second volumetric content according to the request, the second group of volumetric content comprises the second volumetric content, generating the user volumetric content according to the request, the user volumetric content comprises the first volumetric content and the second volumetric content, and providing the user volumetric content to a communication device. Other embodiments are disclosed.

### FIELD OF THE DISCLOSURE

The subject disclosure relates to methods, systems, and devices for on-demand reuse of volumetric content.

### BACKGROUND

Content creation and capture content for entertainment or education purposes has evolved to include volumetric content. In many instances, the content creators generate the volumetric content for a single purpose, without preparing the volumetric content for reuse for a different purpose.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIGS. 2A-2C are block diagrams illustrating example, non-limiting embodiments of a system functioning within the communication network of FIG. 1 in accordance with various aspects described herein.

FIGS. 2D-2F depicts illustrative embodiments of methods in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for obtaining a first group of volumetric content from a first volumetric content source, generating first metadata for the first group of volumetric content, and storing the first group of volumetric content in a volumetric content repository with the first metadata. Further embodiments can include obtaining a second group of volumetric content from a second volumetric content source, generating second metadata for the second group of volumetric content, and storing the second group of volumetric content in the volumetric content repository with the second metadata. Additional embodiments can include receiving a request for user volumetric content from a communication device over a communication network, and obtaining first volumetric content from the volumetric content repository according to the request and the first metadata. The first group of volumetric content comprises the first volumetric content. Also, the embodiments can include obtaining second volumetric content from the volumetric content repository according to the request and the second metadata. The second group of volumetric content comprises the second volumetric content. Further embodiments can include generating the user volumetric content according to the request. The user volumetric content comprises the first volumetric content and the second volumetric content. Additional embodiments can include providing the user volumetric content to the communication device. Other embodiments are described in the subject disclosure.

One or more aspects of the subject disclosure include a device, comprising a processing system including a processor, and a memory that stores executable instructions that, when executed by the processing system, facilitate performance of operations. The operations can comprise obtaining a first group of volumetric content from a first volumetric content source, generating first metadata for the first group of volumetric content, and storing the first group of volumetric content in a volumetric content repository with the first metadata. Further operations can comprise obtaining a second group of volumetric content from a second volumetric content source, generating second metadata for the second group of volumetric content, and storing the second group of volumetric content in the volumetric content repository with the second metadata. Additional operations can comprise receiving a request for user volumetric content from a communication device over a communication network, and obtaining first volumetric content from the volumetric content repository according to the request and the first metadata. The first group of volumetric content comprises the first volumetric content. Also, operations can comprise obtaining second volumetric content from the volumetric content repository according to the request and the second metadata. The second group of volumetric content comprises the second volumetric content. Further operations can comprise generating the user volumetric content according to the request. The user volumetric content comprises the first volumetric content and the second volumetric content. Additional operations can comprise providing the user volumetric content to the communication device.

One or more aspects of the subject disclosure include a non-transitory, machine-readable medium, comprising executable instructions that, when executed by a processing system including a processor, facilitate performance of operations. The operations can comprise obtaining a first group of volumetric content from a first volumetric content source, generating first metadata for the first group of volumetric content, and storing the first group of volumetric content in a volumetric content repository with the first metadata. Further operations can comprise obtaining a second group of volumetric content from a second volumetric content source, generating second metadata for the second group of volumetric content, and storing the second group of volumetric content in the volumetric content repository with the second metadata. Additional operations can comprise receiving a request that indicates a narration for user volumetric content from a communication device over a communication network, and obtaining first volumetric content from the volumetric content repository according to the narration and the first metadata. The first group of volumetric content comprises the first volumetric content. Also, operations can comprise obtaining second volumetric content from the volumetric content repository according to the narration and the second metadata. The second group of volumetric content comprises the second volumetric content. Further operations can comprise generating the user volumetric content according to the narration. The user volumetric content comprises the first volumetric content and the second volumetric content. Additional operations can comprise providing the user volumetric content to the communication device.

One or more aspects of the subject disclosure include a method. The method can comprise obtaining, by a processing system including a processor, a first group of volumetric content from a first volumetric content source, generating, by the processing system, first metadata for the first group of volumetric content, and storing, by the processing system, the first group of volumetric content in a volumetric content repository with the first metadata. Further, the method can comprise obtaining, by the processing system, a second group of volumetric content from a second volumetric content source, generating, by the processing system, second metadata for the second group of volumetric content, and storing, by the processing system, the second group of volumetric content in the volumetric content repository with the second metadata. In addition, the method can comprise receiving, by the processing system, a request that indicates an event for user volumetric content from a communication device over a communication network, and obtaining, by the processing system, first volumetric content from volumetric content repository according to the event and the first metadata. The first group of volumetric content comprises the first volumetric content. Also, the method can comprise obtaining, by the processing system, second volumetric content from volumetric content repository according to the event and the second metadata. The second group of volumetric content comprises the second volumetric content. Further, the method can comprise generating, by the processing system, the user volumetric content according to the event. The user volumetric content comprises the first volumetric content and the second volumetric content. In addition, the method can comprise providing, by the processing system, the user volumetric content to the communication device.

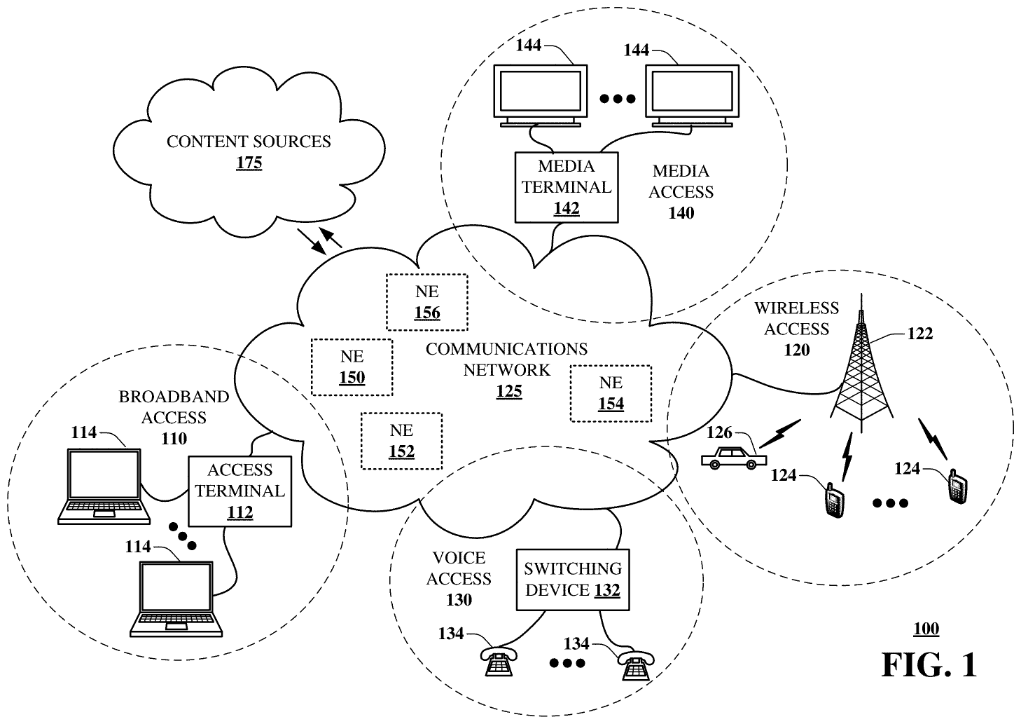

Referring now to FIG. 1, a block diagram is shown illustrating an example, non-limiting embodiment of a system 100 in accordance with various aspects described herein. For example, system 100 can facilitate in whole or in part reuse of portions of previously generated volumetric content to generate user-specific volumetric metric content. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

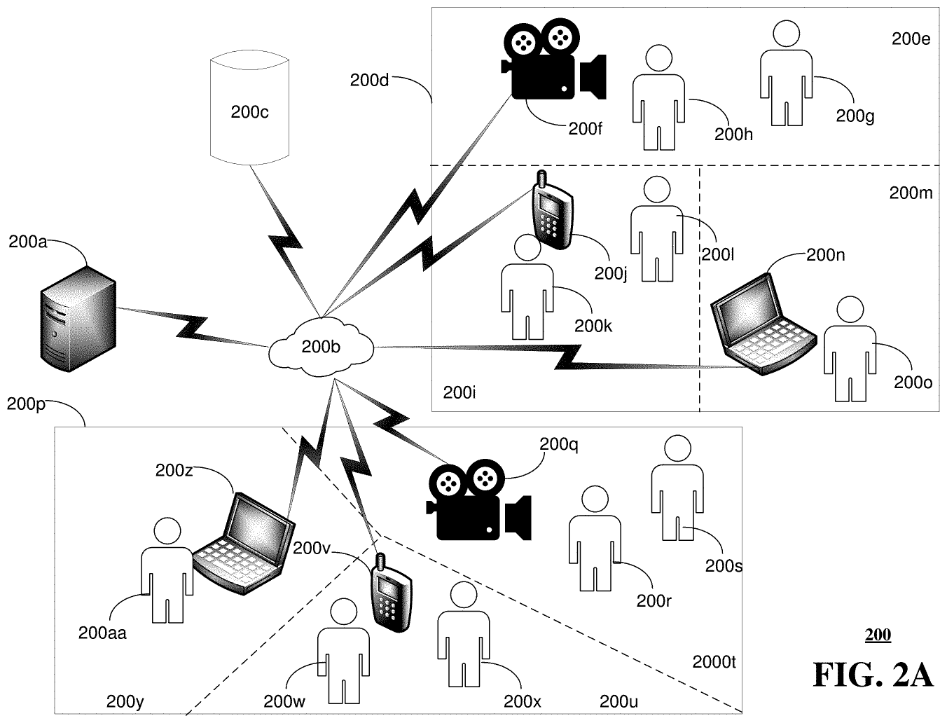

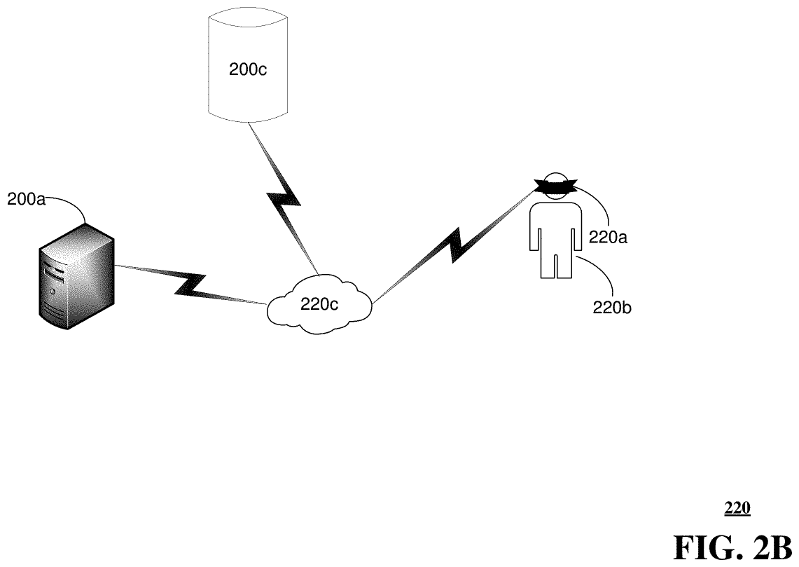

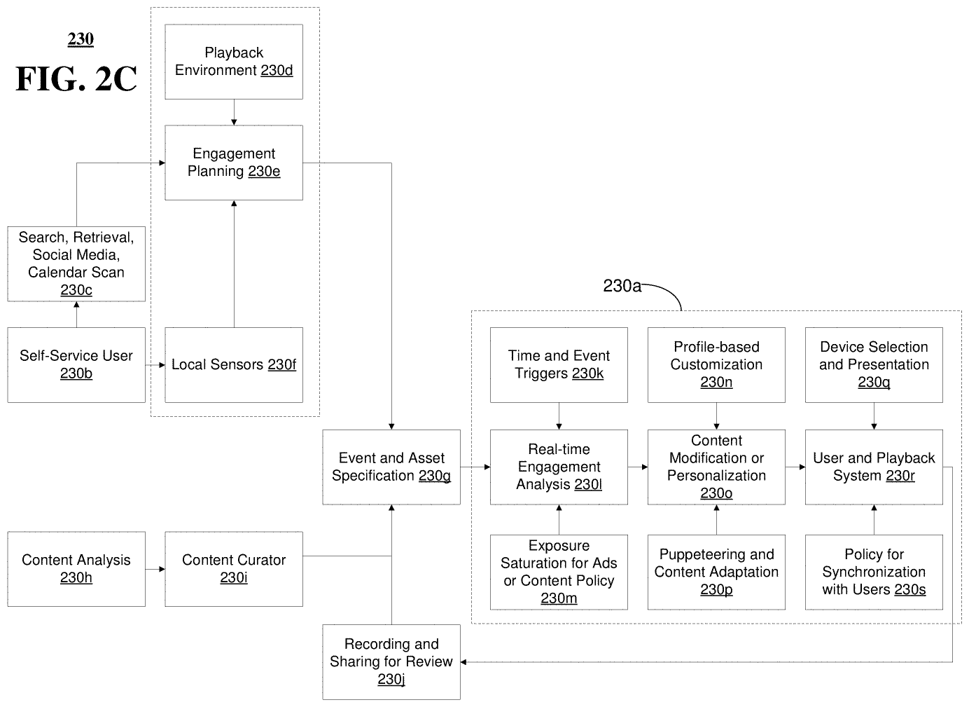

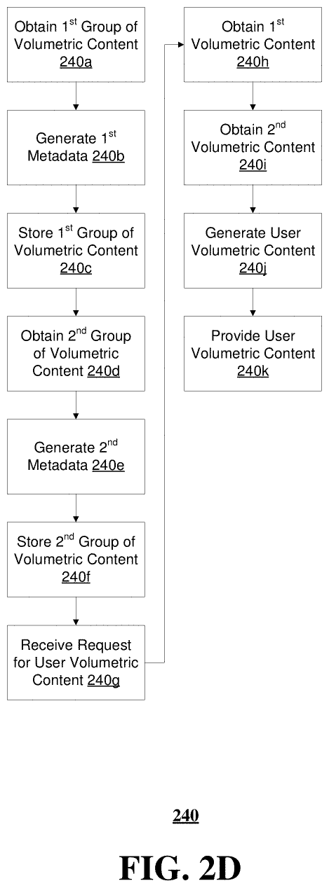

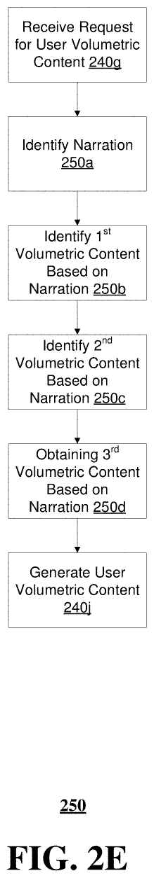

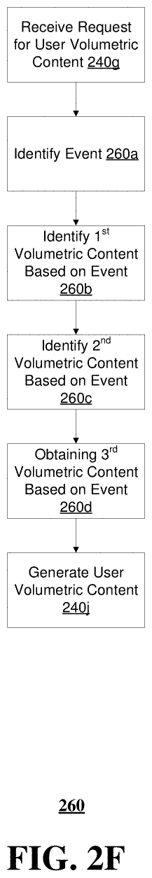

FIGS. 2A-2C are block diagrams illustrating example, non-limiting embodiments of a system functioning within the communication network of FIG. 1 in accordance with various aspects described herein. Embodiments can include capturing, generating, and storing volumetric content for reuse. Volumetric content can be media content that can be three-dimensional (3-D) in nature or provide the appearance of 3-D to a viewer/user and/or can be immersive content that can be presented by a virtual reality device, augmented reality devices, cross reality device, or combination thereof.

In one or more embodiments, as capture of volumetric content for entertainment or education purposes improves, a need and ability to reuse this volumetric content can also be developed for the providing both engaging and cost-effective generation of user-specific volumetric content for a different purpose. One of the challenges in reusing volumetric content is the effective discovery of portions of volumetric content that are relevant for generation of user-specific volumetric content for a different purpose. For example, instead of utilizing an entire five-minute scene that includes volumetric content, specific spoken dialog, gestures, or actions of one or more characters within the volumetric content can be extracted and utilized in the generation of the user-specific volumetric content for the different purpose.

In one or more embodiments, the context of some accessible volumetric content can be more robustly detected and joined with other volumetric content as individual volumetric objects (e.g. scenes, people, activity), but this can require embodiments that can recognize and/or understand the context of generating the volumetric content for a viewer/user, the environment of the viewer/user, and capabilities of the communication device presenting the generated volumetric content to the viewer/user. This context also helps to determine the nature and intent of the volumetric content that is being retrieved to disambiguate between multiple instances (specific objects, location, character activities) in a large volumetric content repository (e.g. a whole season or series).

One or more embodiments can focus on engagement planning (begin, launch, initial considerations) when combining multiple volumetric content assets as well as fitting them to a specific user environment or user intent. This planning may further reduce the search space or modify the extent of volumetric content that can be included. Additionally, this planning may include rendering capabilities like requiring tactile and cross reality (XR) goggles versus holographic renderings, whether on displays, glasses/goggles, or other atmospheric instantiations (walls, smoke, water, etc.).

One or more embodiments include technical innovations to maximally reuse high quality volumetric content assets in the creation and playback of a user-driven immersion volumetric content. Aspects of some embodiments can include effective discovery of volumetric content that can include an analysis for individual objects and components from a rich source of volumetric content that has been previously captured. Other aspects of embodiments can include content for both the viewer/user and the intent of engaging with the generated volumetric content. The current state of the art may include only search criterion for volumetric content assets, but the application of those volumetric content assets is not well described for its display or rendering. Embodiments can include customizations that the viewer/user places on the embodiments for generating the volumetric content. Further aspects of the embodiments can include staging and planning of rich volumetric content assets to provide cohesion. This can include planning of cohesion between volumetric content objects from different volumetric content or volumetric content sources, the view/user intention, and the environment are considered in search results or playback. Specifically for playback environments, the use of volumetric content—both its tools/displays as well as the computation algorithms—are present in planning and generating the volumetric content for the viewer/user.

In one or more embodiments, volumetric content can be generated for a viewer/user for a specific user-sponsored live event that is self-driven through search. Such embodiments are considered self-service in which the user provides and prompts a starting point for generating the volumetric content and some embodiments bootstrap the experience by combining different volumetric content from a different volumetric content sources or volumetric content repositories. The generated volumetric content can provide emotional or situational experience (e.g. birthday, party, murder mystery). Further, the volumetric content can be discovered and suggested to populate that experience, but customization starts from such a point in the generation process.

In one or more embodiments, volumetric content can be generated from an experience template for learning/training or gaming. This can include canned volumetric content stored in a volumetric content repository and/or variations previously generated volumetric content. In some embodiments, the generated volumetric content can be prebuilt by curators or repeat viewer/users that have previously generated volumetric content from the self-service feature described herein. Further embodiments can include allowing access to specific/repeatable narrative volumetric content assets, each of which can be modified slightly for each viewer/user. In some embodiments, an experience template can serve as a “corporate showcase” event that could be shared with other corporate personnel. In other embodiments, users can save the modifications to slightly adjust or finesse some of these changes. For example, a corporate training session on one subject matter that includes generated volumetric content can be changed or modified to include a portion of the previously generated volumetric content but changed slightly to be directed to other subject matter. In another example, embodiments can allow holiday parties year-over-year to gradually grow or adjust according to new venue and user feedback to include not only previously generated volumetric content, but also newly generated volumetric content.

In one or more embodiments, generation of volumetric content can include a curated experience created by authors within a backlot (high curated or personalized). This can include defining some constraints such as environment and necessary volumetric content assets may be needed to provide the environment. Further, the curated experience can include composing and/or sub-selecting different portions of a movie and/or volumetric content assets for programmatic injection of instances. In addition, a curated experience can include a “tour guide” or “personal shopper” experience in which someone could virtually walk through generated volumetric content assets to help create a very complex, but involved event that reuses these volumetric content assets. Also, the curated experience can allow further customization by a user/executive preference. Examples of a curated experience can include reallocation of volumetric content and enhancing the volumetric content in a more immersive manner. Also, a curated experience can improve user both engagement/immersion as well as enhance a business opportunity. Further embodiments can include indexing a curated experience for reuse for future visits of the experience but for different types of users.

Referring to FIG. 2A, in one or more embodiments, system 200 includes server 200a communicatively coupled to volumetric content repository 200c over communication network 200b. Further, the system 200 can include one volumetric content generation system 200d and another volumetric content generation system 200p. Volumetric content generation system 200d includes and a video capture system 200e, a live capture system 200i, and computer generation system 200m. The video capture system 200e can include a video camera 200f capturing images of actor 200g and actor 200h. Further, the live capture system 200i can include a user 200k associated with a mobile device 200j can capture live video content of an event that includes a person 200l. The live event can be a concert such that person 200l is a performer, or the live event can be a sporting event such that person 200l is a player. In addition, the computer generation system 200m can include a user 200o associated with computer 200n generating volumetric content (e.g., animated content, etc.) utilizing the computer. In some embodiments, the user 200o can obtain video content from video camera 200f and/or obtain video content from mobile device 200j utilizing computer 200n over communication network 200b and generate volumetric content based on and/or include the video content from video camera 200f and the video content from mobile device 200j utilizing computer 200n. Further, the user 200o can generate volumetric content from the video content from video camera 200f and video content from mobile device 200j utilizing computer 200n with a volumetric content generation application. In other embodiments, the user 200o can generate volumetric content independent from any video content received from video camera 200f or video content received from mobile device 200j with computer 200n utilizing the volumetric content generation software application. In further embodiments, each of video camera 200f and mobile device 200j can capture video content and generate volumetric content from the captured video content utilizing respective volumetric content generation software applications. Also, the video camera 200f, and/or mobile device 200j can provide video content to the server 200a over communication network 200b. In additional embodiments, the server 200a can generate volumetric content based on the video content obtained from the video camera 200f and/or from the video content obtained from mobile device 200j. The computer 200n can provide volumetric content to the server 200a over communication network 200b. In addition, the server 200a can store the volumetric it has generated and/or the various volumetric content received from the video camera 200f, mobile device 200j, and/or computer 200n into volumetric content repository 200c.

In one or more embodiments, volumetric content generation system 200p includes and a video capture system 200t, a live capture system 200u, and computer generation system 200y. The video capture system 200t can include a video camera 200q capturing images of actor 200r and actor 200s. Further, the live capture system 200u can include a user 200w associated with a mobile device 200v can capture live video content of an event that includes a person 200x. The live event can be a concert such that person 200x is a performer, or the live event can be a sporting event such that person 200x is a player. In addition, the computer generation system 200y can include a user 200aa associated with computer 200z generating volumetric content (e.g., animated content, etc.) utilizing the computer 200z. In some embodiments, the user 200aa can obtain video content from video camera 200q and/or obtain video content from mobile device 200v over communication network 200b utilizing computer 200z and generate volumetric content based on and/or include the video content from video camera 200q and the video content from mobile device 200v. Further, the user 200aa can generate volumetric content from the video content from video camera 200q and video content from mobile device 200v utilizing computer 200z with a volumetric content generation application. In other embodiments, the user 200aa can generate volumetric content independent from any video content received from video camera 200q or video content received from mobile device 200v with computer 200z utilizing the volumetric content generation software application. In further embodiments, each of video camera 200q and mobile device 200v can capture video content and generate volumetric content from the captured video content utilizing respective volumetric content generation software applications. Also, the video camera 200q, and/or mobile device 200v can provide video content to the server 200a over communication network 200b. In additional embodiments, the server 200a can generate volumetric content based on the video content obtained from the video camera 200q and/or from the video content obtained from mobile device 200v. The computer 200z can provide volumetric content to the server 200a over communication network 200b. In addition, the server 200a can store the volumetric it has generated and/or the various volumetric content received from the video camera 200q, mobile device 200v, and/or computer 200z into volumetric content repository 200c.

In one or more embodiments, video capture systems 200e, 200t can include a content generation system that captured video content for a movie. Further, the computer 200n, 200z can receive the video content and enhance the video content (e.g., special effects, etc.) to generate volumetric content. Further, each of the volumetric content generated by volumetric content generation systems 200d, 200p be for one purpose but can be provide to server 200a over communication network 200b to be stored in volumetric content repository 200c to be reused later (or parts of the stored volumetric content) for a different purpose. In addition, the server 200a can generate metadata for each volumetric content received from each volumetric source, (e.g., video camera 200f, mobile device 200j, computer 200n, video camera 200q, mobile device 200v, and computer 200z) and stored the volumetric content into the volumetric content repository 200c with its associated metadata. The metadata can indicate a description of each volumetric content that is searchable via keywords (e.g., generated from a user request) to identify and access the volumetric content or a portion thereof to be reused later for a different purpose. The mobile devices 200j, 200v can comprise a mobile phone, tablet computer, wearable device, laptop computer, or any other mobile device. The communication network 200b can comprise a wireless communication network, a wired communication network, or a combination thereof. The server 200a can comprise one server or multiple servers in one location or spanning multiple locations, one or more cloud servers, one or more virtual servers each co-located or spanning multiple locations. In some embodiments, the volumetric content repository can be stored in the memory of server 200a or a portion thereof. In other embodiments the volumetric content repository 200c can be co-located with the server 200a or portion thereof, or in a remote location of the server 200a.

Referring to FIG. 2B, in one or more embodiments, system 220 can include server 200a communicatively coupled to volumetric content repository 200c and communication device 220a associated with user 220b over communication network 220c. Communication device 220a can comprise a virtual reality (VR) device, an augmented reality (AR) device, a cross reality (XR) device, including, but not limited to, cross reality glasses or goggles, and/or a mobile device. Communication network 220c can comprise a wireless communication network, wired communication network, or a combination thereof. Further, server 200a can receive a request volumetric content from a communication device 220a. The request can indicate that the volumetric content is for a narration for entertainment or gaming purposes or for an event such as a concert, sporting event (to enhance the live video content), or for corporate training. In some embodiments, the server 200a can search the volumetric content repository 200c using keyword generated from the request, narration, or event and identify volumetric content within the volumetric content repository 200c. In some embodiments the server 200a can provide the communication device 220a a selectable list of the identified volumetric content found in the volumetric content repository. Further, the user 220b can select one or more of the identified volumetric content from the list and the communication device 220a can provide an indication to the server 200a of the selected volumetric content. In addition, the server 200a can obtain the volumetric content from the volumetric content repository 200c and generate user volumetric content to include the obtained volumetric content. The obtained volumetric content can include first volumetric content that was generated and obtained from a first volumetric content source (e.g., video camera 200f, 200q mobile device 200j, 200v, computer 200n, 200z) and second volumetric that was generated and obtained from a second volumetric content source (e.g., video camera 200f, 200q, mobile device 200j, 200v, computer 200n, 200z). In addition, the server 200a can request and subsequently obtain other volumetric content from another volumetric content source (e.g., video camera 200f, 200q, mobile device 200j, 200v, computer 200n, 200z) to generate user volumetric content based on the request, narration, or event such that the user volumetric content includes the other volumetric content. The server 200a can provide the user volumetric content to communication device 220a, which then presents the user volumetric content to the user 220b. The user volumetric content can include 3-D media content or media content that can be perceived as 3-D that comprises virtual reality, augmented reality, and/or cross reality components.

Referring to FIG. 2C, in one or more embodiments, system 230 can comprise several components that include a self-service user engine 230b, search, retrieval, social media, calendar scan engine 230c, playback environment engine 230d, engagement planning engine 230e, local sensors 230f, event and asset specification engine 230g, content analysis engine 230h, content curator engine 230i, and recording and sharing for review engine 230j. Further, the system 230 comprises an experience management service components 230a that includes time and event triggers engine 230k, real-time engagement analysis engine 230l, exposure saturation for ads or content policy engine 230m, profile-based customization engine 230n, content modification or personalization engine 230o, puppeteering and content adaptation engine 230p, device selection and presentation engine 230q, user and playback system engine 230r, and a synchronization engine 230s, which can be among users based on a policy.

In one or more embodiments, existing or new volumetric content can be ingested by the content analysis engine 230h and associated metadata for the volumetric content can be generated based on emotional, genre, contextual similarity to known index terms or characters of the volumetric content. Further, the content analysis engine 230h can perform content segmentation both for narrative sections as well as objects within volumetric content. In addition the metadata can include creator contribution for attributes and association of quality of certain volumetric content assets (how expensive to compute) or license limitations.

In one or more embodiments, the content curator engine 230i can design specific volumetric content based on a narration or event using multiple indexed volumetric content assets. Further, the content curator engine 230i can plan certain timed narrative triggers (e.g. saying ‘happy birthday’ or jump scare) as well as may specify different volumetric content path choices for expected audience or context (children, etc.)

In one or more embodiments, the event and asset specification engine 230g can provide an event specification for next delivery (including bootstrap). Further, the self-service user engine 230b and the search, retrieval, social media, and calendar scan engine working in conjunction with one another can conduct a self-service user search and selection of volumetric content assets by example, text, etc. This can include allowing input of social media to also influence search suggestions (etc. favorite action hero). It can also include customization with recommendations from personal user preferences or historical aggregates. In addition, the local sensors 230f for an event can detect or assess available space and capabilities. Also, the engagement planning engine 230e can perform engagement planning for launch, transitions, or other considerations during the presentation of the narration utilizing the generated volumetric content. Also, the playback environment engine 230d can detect the playback environment (e.g., via local sensors 230f) and thereby exclude or include different portions of volumetric content according to the capability of environment (compute cost, project, or XR availability, etc.).

In one or more embodiments, while conducting experience management utilizing the experience management service components 230a that includes execution, the real-time engagement analysis engine 230l can be synchronized by central/distribute management. Further, the time and event triggers engine 230k can allowing specific time and event triggers for narratives (e.g. certain people enter, approach XR content). In addition, the exposure saturation for ads or content policy engine 230m can monitor the saturation state to avoid overexposure to ad content or portions of volumetric content (either sourced or advisements).

In one or more embodiments, the content modification or personalization engine 230o can modify the generated volumetric content prior to delivery to the user's communication device. Further, the profile-based customization engine can accommodate profile-based customizations (allow, personal moderation, choices between curated directions, etc.) of previously generated volumetric content (e.g. static character) and for rendered volumetric content (e.g., NPC rendering). In addition, the puppeteering and content adaptation engine 230p can allow professional/highly-personalized puppeteering of portions of generated volumetric content. In some embodiments, puppeteering can utilize a machine learning application and can manipulate or update visual/audio of characters or objects with expert or remote contributor actions with the generated volumetric content. Further, the experience management service components 230a can deliver the generated volumetric content for optimal user experience. This can include just-in-time filtering by devices for latency and continuous experience by the device selection and presentation engine 230q and/or the user and playback system engine 230r. Also, the experience management service components 230a can provide feedback to original selection of volumetric content. In addition, the recording and sharing for review engine 230j can record and share for aggregated experiences or content for social distribution in conjunction with the synchronization engine 230s.

One or more embodiments enable high reuse of individual objects, characters, and scenes from high-quality volumetric content. Previously these volumetric content assets may be used independently, but embodiments generate volumetric content that include their orchestration and cohesion for user volumetric content. Further, contrary to the current state of the art social media platforms, the planning of a longer-term narrative can be considered. That can include gaming engines as well as a narrative beyond pre-scripted game scenarios into generating volumetric content that includes both user created or highly curated environments. In addition, embodiments include improved planning for resource usage in playback and rendering looking towards proper allocation of cloud, local, and edge compute needs. Also, embodiments include a unique marketplace for user-driven and highly-curated events. Further, embodiments include an ability for reuse of branded volumetric content in one or more user-centric events (e.g. parties, education, etc.) that may have required several additional assets and planning otherwise.

One or more embodiments can include attaching exclusivity or supply of certain assets to specific property. This can be limited by purchase or limited by social opportunity (e.g. user has to be willing to dance and share on social media before this extra character comes online). Further, with this capability the system may add other dressing with previously unused environment areas (e.g. holograms around the room to be used as props to enhance the immersion) even if the primary rendering mechanism is through augmented reality or other technologies. In addition, the system may package the environment to reuse somewhere else. This includes both during the recording or from the planning, a user can allow others to quickly experience the same immersion volumetric content but with tighter controls on synchronization and compatibility across the environments of all remote users. Also, embodiments can include feedback of the generated (immersion) volumetric content that can be expanded in a same (or augmented) scenario. This can include recording and distribution, as well as allowing others to further enhance an experience with subsequent revisions of an event (like a birthday party becoming more oriented for a fantasy or science fiction user). Further, embodiments can use this planning system to improve connection of remote users as well as improving on existing teleconferencing methods, and allowing avatars, the experience, and the objects utilized in that new experience to be better propagated to multiple users at the same time. In addition embodiments can use the same understanding system for decomposition of the cross reality object. This can include feeding back the user's recording to improve and modify the profile of the user outside of this system (e.g., noticing that the user likes to emulate an action hero, propose other scenarios for learning, future entertainment, etc.) that leads to a profile adjustment for “following” or “mimicking” one of those leaders in new media. Whereas the previous experience may have been more rote from the learning content creators.

One or more embodiments can include generating a personalized education and training application for customer service that utilizes generated volumetric content. Further embodiments can include generating museum exhibit (e.g., directed to Neil Amstrong's moon landing) but modified to be presented as an immersive experience utilizing generated volumetric content within an elementary school classroom environment. Additional embodiments can include generating a geological education immersive experience utilizing generated volumetric content. Other embodiment can include intellectual property rights control of the generated volumetric content utilizing non-fungible token (NFT) and/or blockchain technologies.

Note, that components of system 230 can comprise one or more software applications and/or one or more hardware components to perform their functions.

FIGS. 2D-2F depicts illustrative embodiments of methods in accordance with various aspects described herein. Referring to FIG. 2D, in one or more embodiments, aspects of method 240 can be implemented or performed by a server as described herein. The method 240 can include the server, at 240a, obtaining a first group of volumetric content from a first volumetric content source. Further, the method 240 can include the server, at 240b, generating first metadata for the first group of volumetric content. In addition, the method 240 can include the server, at 240c, storing the first group of volumetric content in a volumetric content repository with the first metadata. Also, the method 240 can include the server, at 240d, obtaining a second group of volumetric content from a second volumetric content source. Further, the method 240 can include the server, at 240e, generating second metadata for the second group of volumetric content. In addition, the method 240 can include the server, at 240f, storing the second group of volumetric content in the volumetric content repository with the second metadata. Synthesizing these embodiments in one example, the first group of volumetric content may be a season of recorded volumetric content for Wonder Woman and its related character, plot, and descriptive metadata stored in a database accessible through a search engine. The second group of volumetric content may be a user's living room with geometry, lighting, and occupancy descriptors recorded as the second metadata and stored as a set of specific visual or spatial exemplars in the database.

In one or more embodiments, the method 240 can include the server, at 240g, receiving a request for user volumetric content from a communication device over a communication network. Further, the method 240 can include the server, at 240h, obtaining first volumetric content from the volumetric content repository according to the request and the first metadata. The first group of volumetric content comprises the first volumetric content. In addition, the method 240 can include the server, at 240i, obtaining second volumetric content from the volumetric content repository according to the request and the second metadata. The second group of volumetric content comprises the second volumetric content. Also, the method 240 can include the server, at 240j, generating the user volumetric content according to the request. The user volumetric content comprises the first volumetric content and the second volumetric content. Further, the method 240 can include the server, at 240k, providing the user volumetric content to the communication device. Complementing the synthesized example above, the user request for content includes a query from the exemplars stored in the database, which produces results to obtain first volumetric content (certain volumetric settings for Wonder Woman's home) and action-based results to obtain second volumetric content (volumetric spoken phrases or activities). These two sets of volumetric content are then rendered as a newly generated scene of content and rendered in the user's home via AR headset and ambient holographic displays.

Referring to FIG. 2E, in one or more embodiments, aspects of method 250 can be implemented or performed by a server as described herein. The method 250 can include the server, at 240g, receiving a request for user volumetric content from a communication device over a communication network. Further, the method 250 can include the server, at 250a, identifying a narration of the user volumetric content from the request. In addition, the method 250 can include the server, at 250b, identifying the first volumetric content based on the narration and the first metadata. Also, the method 250 can include the server, at 250c, identifying the second volumetric content based on the narration and the second metadata. Further, the method 250 can include the server, at 250d, obtaining third volumetric content according to the narration. In addition, the method 250 can include the server, at 240j, generating the user volumetric content according to the request. In some embodiments, the generating of the user volumetric content comprises obtaining third volumetric content according to the narration. In further embodiments, the obtaining of the third volumetric content comprises obtaining the third volumetric content from the volumetric content repository. In additional embodiments, the obtaining of the third volumetric content comprises obtaining the third volumetric content from a third volumetric content source.

Referring to FIG. 2F, in one or more embodiments, aspects of method 260 can be implemented or performed by a server as described herein. The method 260 can include the server, at 240g, receiving a request for user volumetric content from a communication device over a communication network. Further, the method 260 can include the server, at 260a, identifying an event of the user volumetric content from the request. In addition, the method 260 can include the server, at 260b, identifying the first volumetric content based on the event and the first metadata. Also, the method 260 can include the server, at 260c, identifying the second volumetric content based on the event and the second metadata. Further, the method 260 can include the server, at 260d, obtaining fourth volumetric content according to the event. In addition, the method 260 can include the server, at 240j, generating the user volumetric content according to the request. In some embodiments, the generating of the user volumetric content comprises obtaining fourth volumetric content according to the event. In further embodiments, the obtaining of the fourth volumetric content comprises obtaining the fourth volumetric content from the volumetric content repository. In additional embodiments, the obtaining of the fourth volumetric content comprises obtaining the fourth volumetric content from a third volumetric content source.

While for purposes of simplicity of explanation, the respective processes are shown and described as a series of blocks in FIGS. 2D-2F, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein. Further, one block may be in response to one or more other blocks.

Portions of some embodiments can be combined with portions of other embodiments. This can include one or more steps of method 240 can be combined with one or more steps of method 250 and/or method 260.

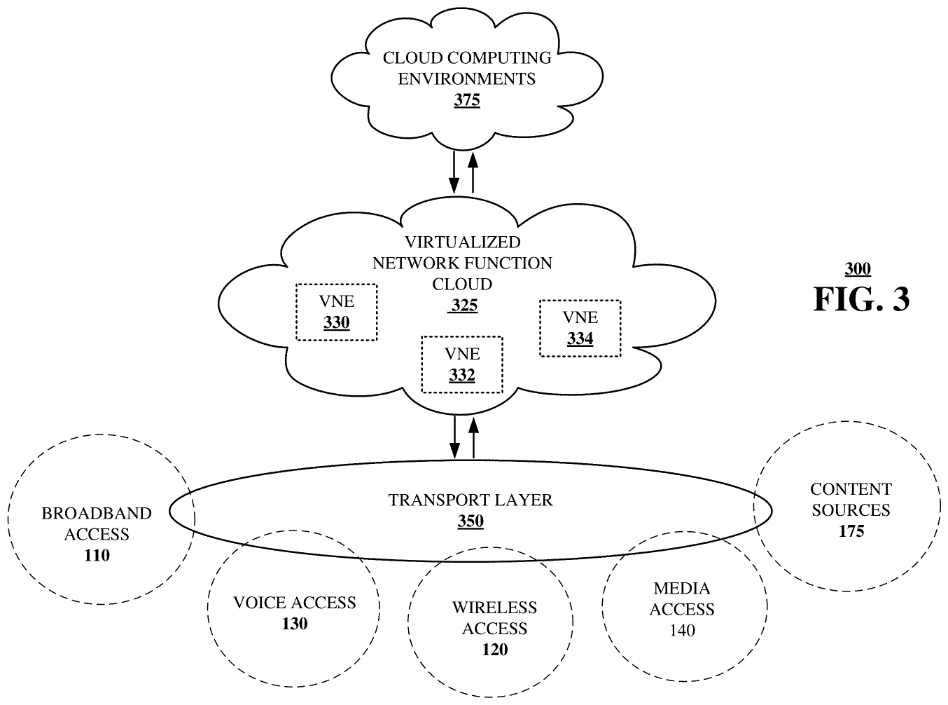

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 100, the subsystems and functions of systems 200, 220, 230 and methods 240, 250, 260 presented in FIGS. 1, 2A-2F, and 3. For example, virtualized communication network 300 can facilitate in whole or in part reuse of portions of previously generated volumetric content to generate user-specific volumetric metric content.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general purpose processors or general purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it's elastic: so the resources are only consumed when needed. In a similar fashion, other network elements such as other routers, switches, edge caches, and middle-boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized, and might require special DSP code and analog front-ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements don't typically need to forward large amounts of traffic, their workload can be distributed across a number of servers—each of which adds a portion of the capability, and overall which creates an elastic function with higher availability than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud, or might simply orchestrate workloads supported entirely in NFV infrastructure from these third party locations.

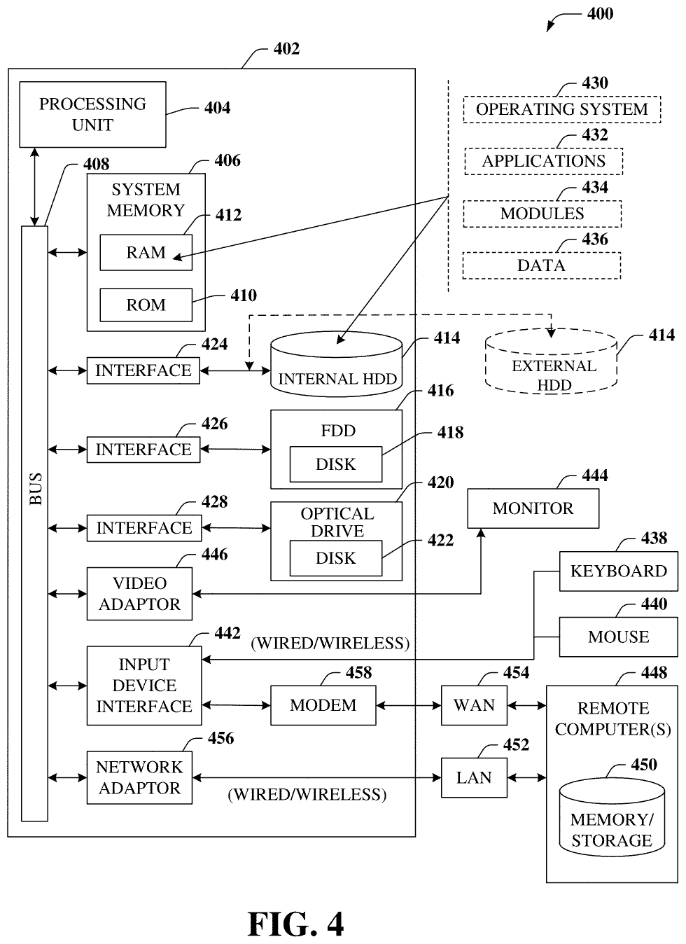

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part reuse of portions of previously generated volumetric content to generate user-specific volumetric metric content. Further, server 200a, volumetric content repository 200c, video camera 200f, mobile device 200j, computer 200n, video camera 200q, mobile device 200v, computer 200z, communication device 220a, and system 230 each can comprise computing environment 400.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM),flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

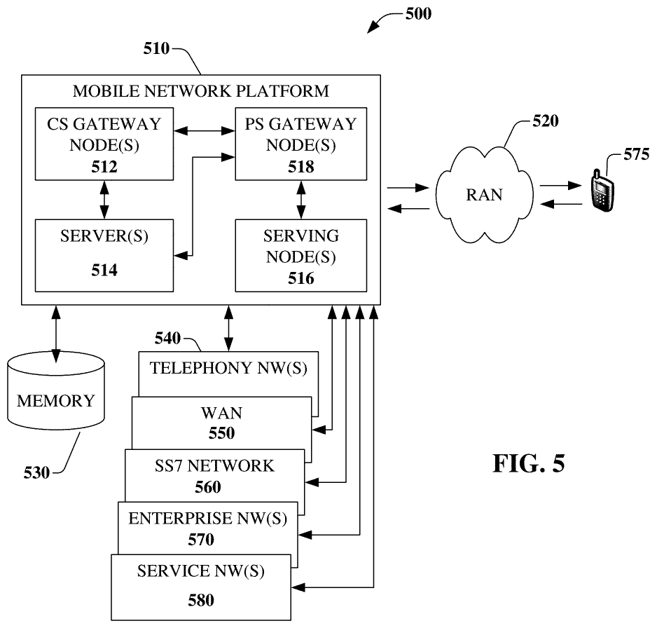

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part reuse of portions of previously generated volumetric content to generate user-specific volumetric metric content. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks, and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processor can execute code instructions stored in memory 530, for example. It is should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

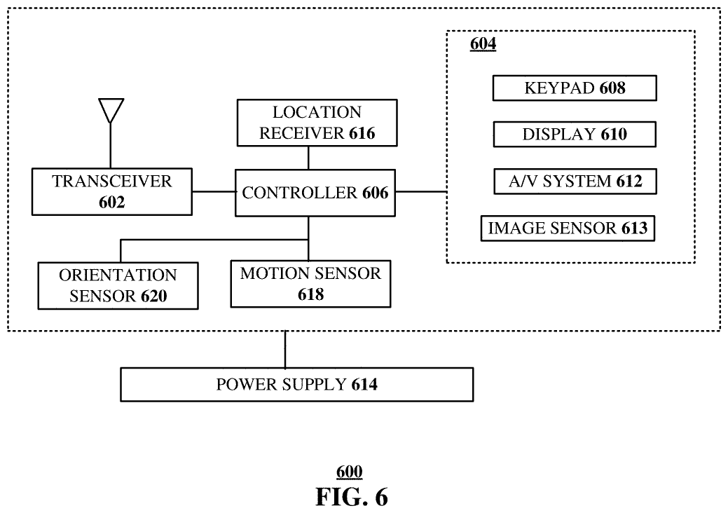

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, communication device 600 can facilitate in whole or in part reuse of portions of previously generated volumetric content to generate user-specific volumetric metric content. Further, server 200a, volumetric content repository 200c, video camera 200f, mobile device 200j, computer 200n, video camera 200q, mobile device 200v, computer 200z, communication device 220a, and system 230 each can comprise communication device 600.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, WiFi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, WiFi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x1, x2, x3, x4, . . . , xn), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
obtaining a first group of volumetric content from a first volumetric content source;
generating first metadata for the first group of volumetric content;
storing the first group of volumetric content in a volumetric content repository with the first metadata;
obtaining a second group of volumetric content from a second volumetric content source;
generating second metadata for the second group of volumetric content;
storing the second group of volumetric content in the volumetric content repository with the second metadata;
receiving a request for user volumetric content from a communication device over a communication network;
obtaining first volumetric content from the volumetric content repository according to the request and the first metadata, wherein the first group of volumetric content comprises the first volumetric content;
obtaining second volumetric content from the volumetric content repository according to the request and the second metadata, wherein the second group of volumetric content comprises the second volumetric content;
generating the user volumetric content according to the request, wherein the user volumetric content comprises the first volumetric content and the second volumetric content; and
providing the user volumetric content to the communication device.

2. The device of claim 1, wherein the operations comprise:
identifying a narration of the user volumetric content from the request;
identifying the first volumetric content based on the narration and the first metadata; and
identifying the second volumetric content based on the narration and the second metadata.

3. The device of claim 2, wherein the generating of the user volumetric content comprises obtaining third volumetric content according to the narration.

4. The device of claim 3, wherein the obtaining of the third volumetric content comprises obtaining the third volumetric content from the volumetric content repository.

5. The device of claim 3, wherein the obtaining of the third volumetric content comprises obtaining the third volumetric content from a third volumetric content source.

6. The device of claim 1, wherein the operations comprise:
identifying an event associated with the user volumetric content from the request;
identifying the first volumetric content based on the event and the first metadata; and
identifying the second volumetric content based on the event and the second metadata.

7. The device of claim 6, wherein the generating of the user volumetric content comprises obtaining fourth volumetric content according to the event.

8. The device of claim 7, wherein the obtaining of the fourth volumetric content comprises obtaining the fourth volumetric content from the volumetric content repository.

9. The device of claim 7, wherein the obtaining of the fourth volumetric content comprises obtaining the fourth volumetric content from a fourth volumetric content source.

10. The device of claim 1, wherein the communication device presents the user volumetric content.

11. The device of claim 1, wherein the communication device comprises a group selected from one of a mobile device, virtual reality device, augmented reality device, and a cross reality device.

12. A non-transitory, machine-readable medium, comprising executable instructions that, when executed by a processing system including a processor, facilitate performance of operations, the operations comprising:
obtaining a first group of volumetric content from a first volumetric content source;
generating first metadata for the first group of volumetric content;
storing the first group of volumetric content in a volumetric content repository with the first metadata;
obtaining a second group of volumetric content from a second volumetric content source;
generating second metadata for the second group of volumetric content;
storing the second group of volumetric content in the volumetric content repository with the second metadata;
receiving a request that indicates a narration for user volumetric content from a communication device over a communication network;
obtaining first volumetric content from the volumetric content repository according to the narration and the first metadata, wherein the first group of volumetric content comprises the first volumetric content;
obtaining second volumetric content from the volumetric content repository according to the narration and the second metadata, wherein the second group of volumetric content comprises the second volumetric content;
generating the user volumetric content according to the narration, wherein the user volumetric content comprises the first volumetric content and the second volumetric content; and
providing the user volumetric content to the communication device.

13. The non-transitory, machine-readable medium of claim 12, wherein the generating of the user volumetric content comprises obtaining third volumetric content according to the narration.

14. The non-transitory, machine-readable medium of claim 13, wherein the obtaining of the third volumetric content comprises obtaining the third volumetric content from the volumetric content repository.

15. The non-transitory, machine-readable medium of claim 14, wherein the obtaining of the third volumetric content comprises obtaining the third volumetric content from a third volumetric content source.

16. The non-transitory, machine-readable medium of claim 14, wherein the communication device presents the user volumetric content.

17. The non-transitory, machine-readable medium of claim 14, wherein the communication device comprises a group selected from one of a mobile device, virtual reality device, augmented reality device, and a cross reality device.

18. A method, comprising:
obtaining, by a processing system including a processor, a first group of volumetric content from a first volumetric content source;
generating, by the processing system, first metadata for the first group of volumetric content;
storing, by the processing system, the first group of volumetric content in a volumetric content repository with the first metadata;
obtaining, by the processing system, a second group of volumetric content from a second volumetric content source;
generating, by the processing system, second metadata for the second group of volumetric content;
storing, by the processing system, the second group of volumetric content in the volumetric content repository with the second metadata;
receiving, by the processing system, a request that indicates an event for user volumetric content from a communication device over a communication network;
obtaining, by the processing system, first volumetric content from volumetric content repository according to the event and the first metadata, wherein the first group of volumetric content comprises the first volumetric content;
obtaining, by the processing system, second volumetric content from volumetric content repository according to the event and the second metadata, wherein the second group of volumetric content the second volumetric content;
generating, by the processing system, the user volumetric content according to the event, wherein the user volumetric content comprises the first volumetric content and the second volumetric content; and
providing, by the processing system, the user volumetric content to the communication device.

19. The method of claim 18, wherein the generating of the user volumetric content comprises obtaining, by the processing system, third volumetric content according to the event.

20. The method of claim 18, wherein the communication device presents the user volumetric content.
